(19) United States
(12) Patent Application Publication
(10) Pub. No.: US 2006/0252014 A1
(43) Pub. Date: Nov. 9, 2006

(54) Intelligence-adjusted cognitive evaluation system and method

(76) Inventors: Ely S. Simon, Bayside, NY (US); Glen M. Doniger, Houston, TX (US)

Correspondence Address: DANIEL J SWIRSKY, 55 REUVEN ST., BEIT SHEMESH, 99544, IL

(21) Appl. No.: 11/124,369

(22) Filed: May 9, 2005

(51) Int. Cl. G09B 19/00

(52) U.S. Cl. 434/236

(57) ABSTRACT

A system and methods for providing intelligence-adjusted cognitive performance measures includes a cognitive test and an intelligence test. Results from the intelligence test are used to adjust performance measures obtained from the cognitive tests, in order to correct for differences in IQ.

### FIELD OF THE INVENTION

The present invention relates to a cognitive testing system and method and, more particularly, to a method for quantitative adjustment of standardized cognitive scores based upon a marker of general intelligence.

### BACKGROUND OF THE INVENTION

Cognition is a general term for mental processes by which an individual acquires knowledge, solves problems, and plans activities. Cognitive skills include attention, visual/spatial perception, judging and decision-making, problem solving, memory and verbal function, among others. The functional levels of each of these skills can be studied alone or in combination for a particular individual.

Evaluation and quantification of cognitive ability has been a challenge to both scientists and clinicians. This information is important for enabling quick and accurate diagnoses, for directing treatments, and for tracking the patient's response to medical, surgical, or rehabilitation therapies. Additionally, cognitive evaluation is useful for many other applications, such as vocational screening, evaluations in the educational system to determine special needs, evaluations in the military to determine suitability for specific units and/or effects of regimens such as chemical agents, g-forces and diving depth. In short, accurate evaluation of cognitive ability can have far-reaching results in many different areas.

The task of evaluating and quantifying cognitive ability is even more challenging for people with lower or higher than average intelligence, since results from cognitive tests do not generally include information about baseline performance, making it difficult to evaluate improvements or declines. For example, a person of higher than average intelligence may perform adequately on a given cognitive test, but there may be an unrevealed decline in performance for the individual's intelligence level, possibly causing a missed diagnosis. Conversely, a person of lower than average intelligence may be erroneously diagnosed with a neurological condition when, in reality, for the individual's intelligence level performance is acceptable.

To date, this problem has been addressed at most by consideration of results from a separate IQ test, and subjective decision making as to how to apply the results. This subjective decision is generally made by the clinician, and can vary from individual to individual and also over time for a particular patient. There currently lacks a quantifiable method and system for including intelligence measures in the calculation of scores and reporting of such scores in a meaningful way in cognitive tests.

### SUMMARY OF THE INVENTION

According to one aspect of the invention, there is provided a system for cognitive testing. The system includes a cognitive test, configured to provide at least one cognitive performance outcome, an intelligence test, configured to provide an intelligence measure, and a processor having a performance data receiver, for receiving the cognitive performance outcome, an intelligence data receiver for receiving the intelligence measure, and an adjustor for adjusting the cognitive performance outcome based on the intelligence measure.

According to another aspect of the invention, there is provided a method of cognitive testing. The method includes obtaining a measure of intelligence, obtaining a performance outcome measure for a cognitive skill from a computerized cognitive test, comparing the performance outcome measure to an expected performance outcome measure based on the measure of intelligence, and quantifiably adjusting the performance outcome measure based on the comparison.

According to yet another aspect of the invention, there is provided a method of cognitive testing. The method includes obtaining a measure of intelligence, obtaining a performance outcome measure from a computerized cognitive test for a cognitive parameter, calculating an expected performance outcome measure based on correlations of intelligence to the cognitive parameter, calculating a discrepancy between the obtained performance outcome measure and the expected performance outcome measure, and adjusting the obtained performance outcome measure based on the discrepancy.

According to yet another aspect of the invention, there is provided a method of cognitive testing. The method includes obtaining a measure of intelligence, obtaining a performance outcome measure from a computerized cognitive test, stratifying the obtained performance outcome measure according to the measured intelligence, and adjusting the obtained performance outcome measure based on the stratification.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart illustration of a basic overview of the present invention;

FIG. 2 is a block diagram illustration of a testing system which in a preferred embodiment is used as the cognitive test portion of the system depicted in FIG. 1;

FIG. 3 is a screen shot taken from a Problem Solving test, in accordance with one preferred embodiment of the present invention;

FIG. 4 is a block diagram illustration of a system in accordance with a preferred embodiment of the present invention;

FIG. 5 is a flow chart illustration of the steps of a method of adjusting a performance outcome measure based on a baseline intelligence measure, in accordance with one preferred embodiment of the present invention;

FIG. 6 is a flow chart illustration of the steps of a method of adjusting a performance outcome measure based on a baseline intelligence measure, in accordance with another embodiment of the present invention;

FIGS. 7A and 7B are illustrations of graphs which may be included in a report in accordance with a preferred embodiment of the present invention;

FIG. 8 is a graphical illustration of results of a validity assessment, depicting the greatest amount of adjustment for high and low IQ individuals; and

FIG. 9 is a graphical illustration of results of the validity assessment of FIG. 8, indicating specific areas of cognition.

### DESCRIPTION OF THE PREFERRED EMBODIMENTS

The present invention is of an intelligence-adjusted computerized cognitive testing system. Specifically, the present invention can be used to provide a measure of cognitive function with adjusted outcome parameters based on baseline intelligence measures.

The principles and operation of an intelligence-adjusted computerized cognitive testing system according to the present invention may be better understood with reference to the drawings and accompanying descriptions.

Before explaining at least one embodiment of the invention in detail, it is to be understood that the invention is not limited in its application to the details set forth in the following description or illustrated in the drawings. The general principles of the present invention will be described with reference to several embodiments. However, the invention is capable of other embodiments or of being practiced or carried out in various ways with many alternatives, modifications and variations, and many other tests may fall within the realm of the present invention. Accordingly, it is intended to embrace all such alternatives, modifications and variations that fall within the spirit and broad scope of the appended claims. Also, it is to be understood that the phraseology and terminology employed herein is for the purpose of description and should not be regarded as limiting.

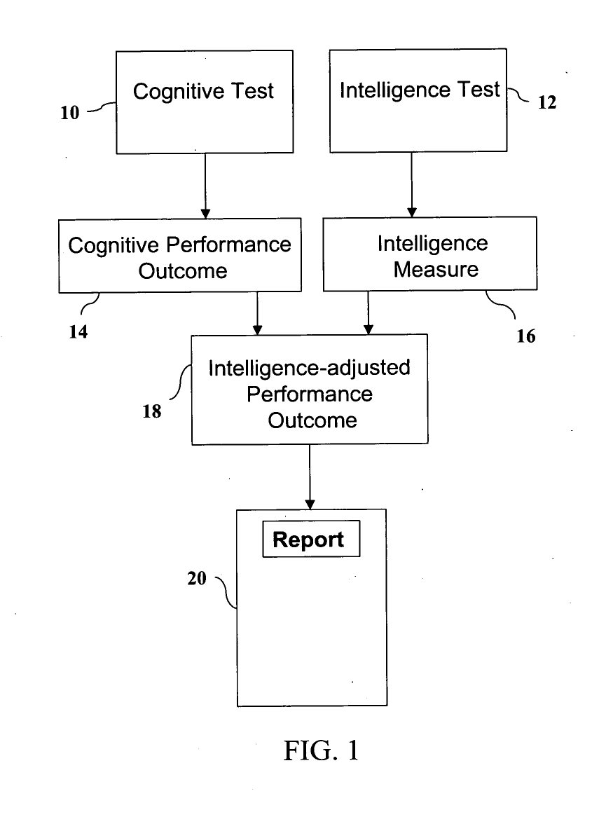

Referring now to the drawings, FIG. 1 is a flow chart illustration of an overview of the system and method of the present invention. A computerized cognitive test 10 and an intelligence test 12 are both administered to a testing subject. Cognitive test 10 alone provides at least one cognitive performance outcome 14, which is an adequate measure of cognitive performance for an individual with average intelligence, but which may not provide a clear cognitive picture for an individual with high or low intelligence. Intelligence test 12 provides a baseline intelligence measure 16, which is used to adjust cognitive performance outcome 14 to provide an intelligence-adjusted cognitive performance outcome 18. Intelligence-adjusted cognitive performance outcome 18 is presented in a report 20. In one embodiment, cognitive performance outcome 14 and baseline intelligence measure 16 are also presented in report 20.

Cognitive test 10 and intelligence test 12 may be administered in any order. In one embodiment, intelligence test 12 is given at an earlier date than cognitive test 10, and results are stored for any future cognitive tests given to the same individual. In a preferred embodiment, intelligence test 12 is given during the same testing session as cognitive test 10.

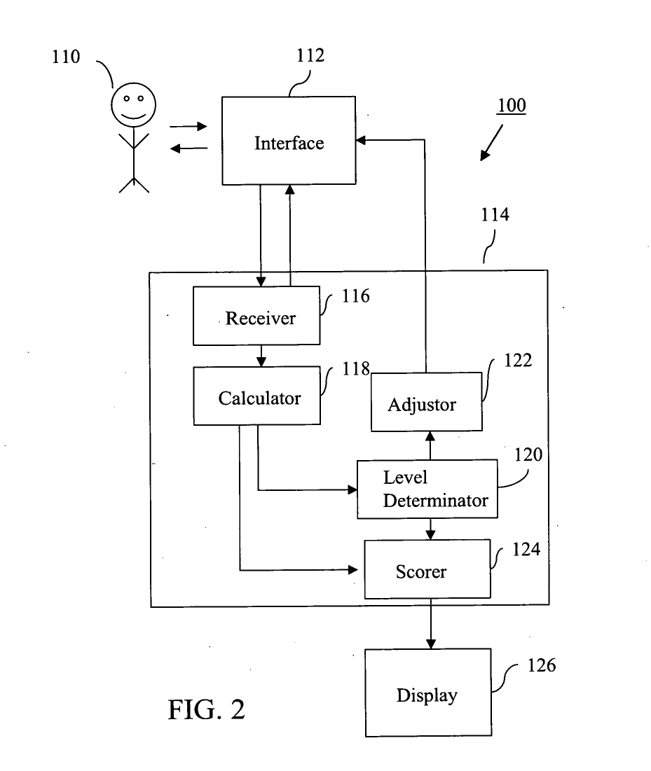

Cognitive test 10 is any suitable computerized cognitive test, and may be designed to measure a particular cognitive skill, or may include a battery of cognitive tests to measure a condition or to obtain a general picture of the neurological condition of the tested individual. Examples of such tests are described, for example, in co-pending U.S. patent application Ser. No. 10/370,463 and in co-pending U.S. patent application Ser. No. 10/971,067, both of which are incorporated herein by reference in their entireties. As an overview of the cognitive testing system disclosed in the above-referenced applications, reference is now made to FIG. 2, which is a block diagram illustration of a testing system 100. A subject 110 being tested is in communication with testing system 100 via an interface 112. Interface 112 is configured to accept data collected by responses of subject 110 to stimuli provided by testing system 100. Interface 112 communicates with system 100 via a processor 114, configured to accept and analyze the data, provide feedback to subject 110, adjust the testing scheme, and send results. Processor 114 has a receiver 116 for receiving data, a calculator 118 for calculating performance, a level determinator 120, for determining a skill level of subject 110, an adjustor 122 for adjusting the level of testing, and a scorer 124 for determining a score based on the received data. The processor sends the processed score information to a display 126. Display 126 may be an audio or visual display, and is either directly or remotely connected to the rest of system 100.

Initially, a stimulus is presented to subject 110, who then responds to the stimulus. Both the presentation of the stimulus and the response thereto are directed through interface 112. In a preferred embodiment, interface 112 is a computer system having an input such as a mouse, keypad, joystick or any other input device, and a display for presentation of the stimulus. It should be readily apparent that any system useful for presentation of a stimulus and collection of responses may be used. However, it is preferable that interface 112 be intuitive and simple to understand. If necessary, an orientation session is provided so as to familiarize subject 110 with interface 112, thereby eliminating the possibility of bias due to lack of familiarity with the technology.

Receiver 116 collects responses from subject 110 through interface 112, and sends the data to a calculator 118. Calculator 118 calculates performance factors, such as accuracy, speed, etc. General performance is rated based on certain predefined criteria, such as threshold levels, percentage of accurate responses, or any other criterion deemed to be relevant. Calculator 118 sends performance data to level determinator 120 and to scorer 124. Level determinator 120 determines an appropriate level of testing based on the performance data, and sends the data to both adjustor 122 and to scorer 124. Adjustor 122 adjusts the level of testing, which is directed through interface 112 to subject 110 for additional testing. In many instances, the determined level is also useful in calculating a final score. Scorer 124 uses data from level determinator 120 and from calculator 118 to determine a score. The score may be presented in the form of a number, a series of numbers, a chart or a graph or any other format. The score is sent to display 126 either via direct or remote connection, which then displays the score in an easily readable format.

Specific examples of tests fit into several categories, including motor skills, visual/spatial perception, memory, information processing, verbal function, and executive function. Motor skills tests include, for example, a finger tap test, for assessing speed of tapping and regularity of finger movement; and a catch test wherein a subject is asked to catch a first object falling from the top of a screen using a second object on the bottom of the screen, for assessing hand/eye coordination, speed of movement, motor planning and spatial perception. Visual/spatial perception tests include, for example, the catch test described above; a non-verbal memory test, as described below, and a three-dimensional spatial orientation test, wherein a subject is asked to identify a view from a specific perspective, for assessing spatial perception and mental rotation capabilities. Memory tests include, for example, a verbal memory test, whose purpose is to evaluate a subject's ability to remember pairs of words that are not necessarily associated with one another; a non-verbal memory test, whose purpose is to evaluate a subject's ability to remember the spatial orientation of a picture. Information processing tests include, for example, a staged math test including simple mathematical problems to evaluate a subject's ability to process information, testing both reaction time and accuracy. Verbal function tests include, for example, a verbal naming and rhyming test using semantic foils, requiring an executive function (frontal lobes of the brain) to suppress the natural tendency towards the semantic foil, favoring the phonological choice. The naming test is a subtest of the rhyming test, which serves to test different verbal skills than the rhyming test and to control for cultural bias. Executive function tests include, for example, a stroop test, in which the subject is shown words having the meaning of specific colors written in colors other than the ones indicated by the meaning of the words; and a Go/No Go Response Inhibition test to evaluate concentration, attention span, and the ability to suppress inappropriate responses. Any of the above tests can be used for cognitive test 10 of the present invention.

Intelligence test 12 is any suitable test which measures general intelligence (IQ). In a preferred embodiment, intelligence test 12 is a computerized test, and response data are automatically included with electronic data from cognitive test 10. In alternative embodiments, data from intelligence test 12 are either computer based or paper based, and are manually entered into the computerized system. Examples of intelligence tests that may be used for the present invention include the Wechsler Adult Intelligence Scale (WAIS), the Wechsler Intelligence Scale for Children (WISC), the Stanford-Binet Intelligence scale, the Test of Non-verbal Intelligence (TONI), and others.

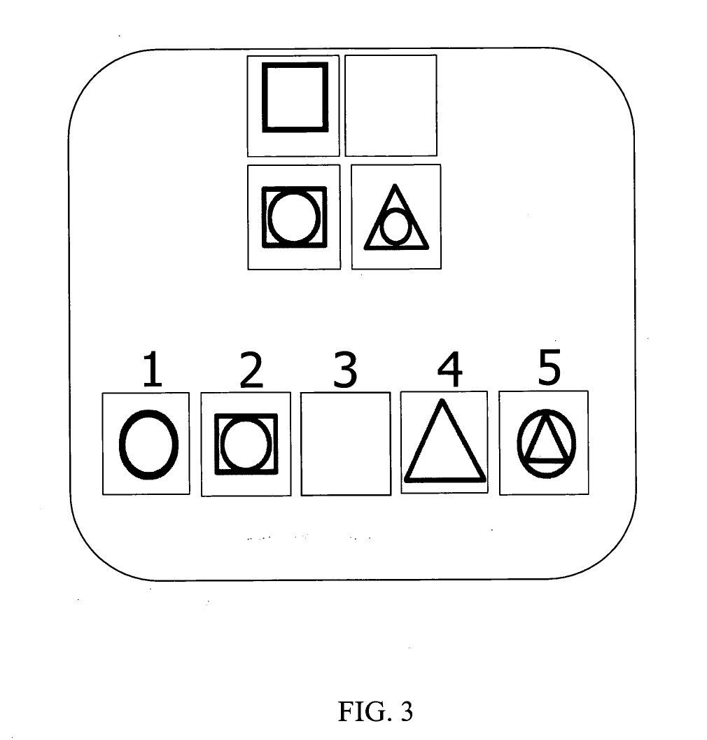

In a preferred embodiment, intelligence test 12 is a Problem Solving test, which has been designed specifically for the purpose of the present invention. The Problem Solving test is a test of non-verbal IQ that assesses the ability to appreciate spatial relationships among geometric forms in a pattern. Specifically, patterns of geometric shapes are presented, and the individual must choose the correct geometric form in accordance with the established pattern. Patterns are presented in order of increasing difficulty. Thus, for example, at a first level, a particular shape is presented three times facing the same direction. The correct response is the same shape in the same direction. Increasing levels of difficulty may include changing the orientation of the geometric form, use of negative images, and the use of several forms within one form. An example of a screen shot from the Problem Solving test is depicted in FIG. 3. Four squares are depicted as follows. An upper left square has a square shape. A lower left square has a square shape with a circle shape nested inside the square shape. A lower right square has a triangle shape with a circle shape nested in the triangle shape. An upper right square is blank. The user must choose from five options to fill in the blank upper right square. The correct answer is a triangle shape. Other options are given, including a circle, a circle in a square, a blank screen and a triangle inside a circle. This particular example is at an intermediate level of difficulty. The test is based on known tests, such as the Test of Nonverbal Intelligence, 3rd Edition (TONI-3; Brown, L., Sherbenou, R. & Johnson, S. (1997) Test of Nonverbal Intelligence. 3^{rd} Edition. Austin, Tex.: Pro-Ed.), or Raven's Progressive Matrices (Raven JC (1982): Revised Manual for Raven's Progressive Matrices and Vocabulary Scales. Windsor: NFER-Nelson), which have been used to measure intelligence in individuals of diverse educational levels and cultural backgrounds. However, the Problem Solving test disclosed herein is adaptive in nature, including various levels of testing and scoring, multiple trials at each level, the possibility of a cut-off in the event that an individual cannot perform above a certain level, practice tests, minimization of subjective assessment, and other features, all of which are described more fully in reference to cognitive test 10 above. In an alternative embodiment, a combination of verbal and non-verbal tests can be used.

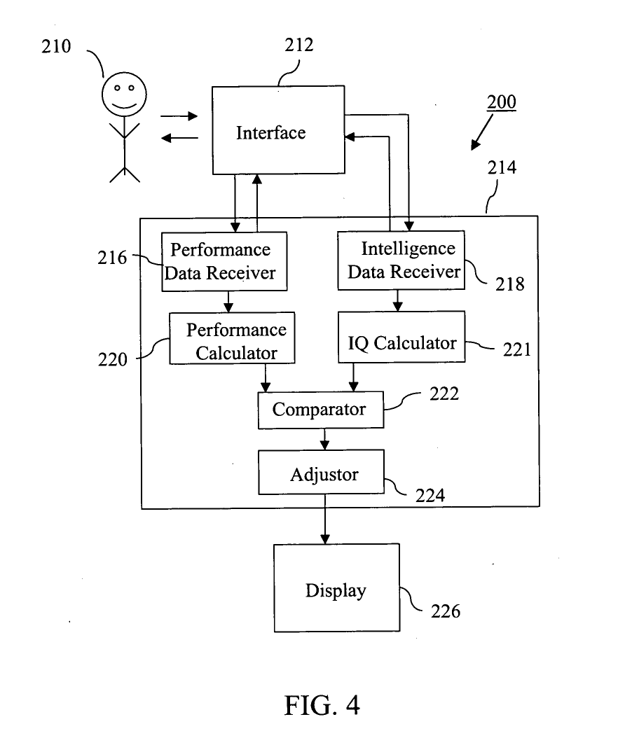

Reference is now made to FIG. 4, which is a block diagram illustration of a system 200 in accordance with a preferred embodiment of the present invention. A testing subject 210 is in communication with system 200 via an interface 212. Interface 212 is configured to accept data collected by responses of subject 210 to stimuli from cognitive test 10 and intelligence test 12. System 200 includes a processor 214, configured to accept and analyze the data, provide feedback to subject 210, make adjustments, and send results. Processor 214 has a performance data receiver 216 and an intelligence data receiver 218. Performance data receiver 216 receives data from responses to stimuli from cognitive test 10, while intelligence data receiver 218 receives data from responses to stimuli from intelligence test 12. Processor 214 further includes a performance calculator 220 for calculating performance outcome measures based on the data received from responses to stimuli from cognitive test 10, and an IQ calculator 221 for calculating a baseline intelligence measure based on the data received from responses to intelligence test 12. A comparator 222 in communication with both performance calculator 220 and IQ calculator 221 is configured to compare calculated performance outcome measures to expected performance outcome measures for baseline intelligence measures calculated by IQ calculator 221. Processor 214 further includes an adjustor 224 for adjusting the calculated performance outcome measures based on the comparison with expected performance outcome measures, thus providing an intelligence-adjusted cognitive performance measure, which can be sent to a display 226. Display 226 may be an audio or visual display, and is either directly or remotely connected to the rest of system 200. In a preferred embodiment, display 226 is a report, as described further hereinbelow.

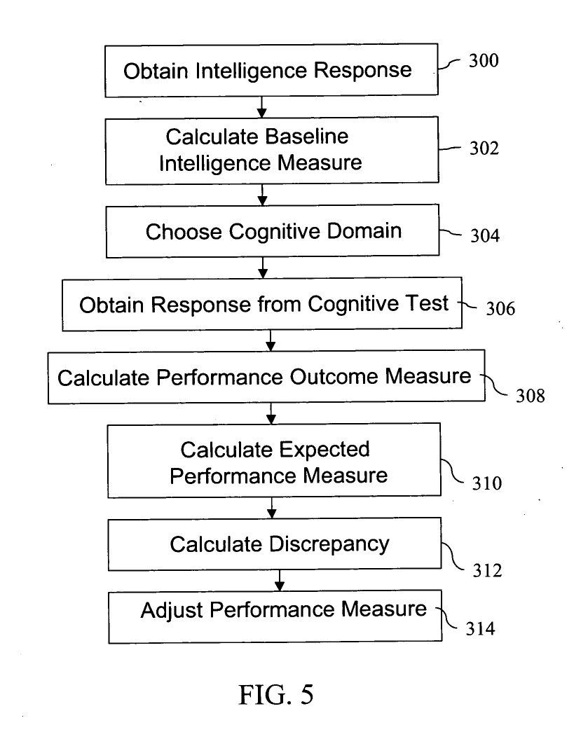

Referring now to both FIG. 4 and FIG. 5, FIG. 5 is a flow chart illustration of the steps of a method of adjusting a performance outcome measure based on a baseline intelligence measure, in accordance with one preferred embodiment of the present invention. First, intelligence data receiver 118 obtains (step 300) responses to intelligence test 12. Next, IQ calculator 221 calculates (step 302) a baseline intelligence measure from intelligence test 12. Next, the user chooses (step 304) a cognitive domain to test. The step of choosing a cognitive domain can also be performed prior to the steps of obtaining responses to intelligence test 12 and calculating a baseline intelligence measure. In preferred embodiments, the user is a clinician, such as a neurologist, psychologist, neuropsychologist, or any other individual suitable for collecting cognitive data. The chosen cognitive domain may be a specific category, such as memory or attention. Alternatively, the chosen cognitive domain may be a condition or a general area of cognition, such as mild cognitive impairment (MCI) or traumatic brain injury (TBI). Batteries for various conditions are available, for example, through Mindstreams® (Neurotrax Corp., NY). Performance data receiver 116 then obtains (step 306) responses from cognitive test 10. Calculator 120 then calculates (step 308) a performance outcome measure from the responses. The steps of obtaining responses and calculating a performance outcome measure may be performed during the same testing session as obtaining a baseline intelligence measure (step 302) in a preferred embodiment, or at an earlier or later date, in alternative embodiments. In one embodiment, the performance outcome measure is a single outcome from a single trial of a test. Raw performance measures are converted to a standardized scale (such as an IQ scale or a z-scale), and are normalized according to age and education. Comparator 122 then calculates (step 310) an expected performance measure based on the calculated baseline intelligence measure, and calculates (step 312) a discrepancy from the expected performance outcome measure. Adjustor 224 adjusts (step 314) the performance outcome measure calculated in step 308 to account for the discrepancy calculated in step 312. The adjusted performance outcome measure can then be converted into index scores, based on at least two outcomes from a single trial of a test or at least one outcome from each of at least two tests (wherein both tests are designed to test a similar cognitive skill) or into composite scores, calculated from a combination of at least two index scores designed to test a similar cognitive skill. Calculation of index scores and composite scores are described more fully in co-pending U.S. patent application Ser. No. 10/370,463 and in co-pending U.S. patent application Ser. No. 10/971,067, both of which are incorporated herein by reference in their entireties.

The discrepancy calculation of step 312 can be accomplished in various ways, and as such, the method of the present invention encompasses all such possibilities, and is not limited by the examples included herein. In a first example, calculations are based on pre-determined correlations between intelligence and specific cognitive skills. Specifically, correlation tables are created based on experimental data collected from the normative sample and stratified according to age, education and intelligence for each performance measure. Thus, for each individual outcome measure at each particular age and at each particular education level, the individual outcome measures collected from the normative sample are linearly correlated with intelligence measures collected from intelligence tests (in a preferred embodiment, the Problem Solving Test) from the same normative sample. This linear correlation value is then used in the discrepancy calculation of step 312 in each individual outcome measure. Individual outcome measures include, for example, a measure of verbal memory, or a reaction time in a finger tapping test, or any other measurement obtained from cognitive test 10. In a preferred embodiment, the discrepancy score is calculated as the difference between the expected and obtained outcomes, expressed as z-values. In alternative embodiments, other arithmetic calculations can be used, such as a ratio of expected and obtained outcomes. Correlation values can be updated as often as desired based on new experimental data. In an alternative embodiment, correlation values are obtained from published literature.

The adjustment calculation of step 314 is accomplished using the discrepancy measure. In one embodiment, the adjusted score is calculated by dividing the discrepancy score by its standard deviation. Other embodiments may include different arithmetic or mathematical manipulations. Regardless of the actual method of adjustment, it should be readily apparent that the score itself is adjusted in accordance with intelligence measures.

As an alternative to correlations, expected performance outcome measures can be obtained using known expectancy formulas, such as, for example, those described in published articles for calculating discrepancies from intelligence for learning disability determination (Kavale K A, “Discrepancy models in the identification of learning disability”, National Research Center on Learning Disabilities, 2001). Such formulae can include a combination of variables, such as age, educational level, or other socio-economic factors. Discrepancy can be calculated by subtraction, or as a ratio, or any other suitable calculation.

Expected effects of the discrepancy-based IQ-adjustment for individuals who score low, medium, and high on an intelligence test are as follows. For low-IQ individuals, the adjustment raises their outcome parameter score, for high-IQ individuals, the adjustment lowers their outcome parameter score, and for average-IQ individuals, the adjustment can either raise or lower their score. Adjustments are expected to be much greater for low- and high-IQ as compared with average-IQ individuals.

For a low-IQ individual, poor outcome parameter performance results in little adjustment as the individual is performing as expected on the basis of the intelligence measure. However, average outcome parameter performance by the same low-IQ individual results in a larger adjustment because the individual is performing better than expected. Further, excellent outcome parameter performance by this low-IQ individual results in an even larger adjustment because the performance is much better than would be expected on the basis of the intelligence measure.

For an average-IQ individual, poor outcome parameter performance results in moderate adjustment to bring outcome parameter performance down. The individual is performing lower than expected on the basis of the intelligence measure and as such, is penalized. With average outcome parameter performance, there will be little adjustment for the same average-IQ individual as the individual is performing as expected. If the average-IQ individual exhibits exceptional outcome parameter performance, the score may be adjusted (depending upon strength of correlation or other relevant factors) slightly to bring outcome parameter performance up as the individual is performing somewhat better than expected on the basis of the intelligence measure.

For a high-IQ individual, poor outcome parameter performance can result in a large adjustment to bring performance down as the individual is performing more poorly than expected. If the same high-IQ individual shows average performance on the outcome parameter, the adjustment can result in a moderate downward adjustment as the individual is performing more poorly than anticipated. Finally, if a high-IQ individual performs shows excellent outcome parameter performance, the adjustment is relatively small given that performance is consistent with expectation based upon the intelligence measure.

In the case of correlation determinations of expected performance, strength of correlation modulates the extent of adjustment such that greater strength of correlation results in greater adjustment. If the correlation is low, the relationship between the intelligence measure and outcome parameter performance is weak and hence a correction on this basis cannot be great. If, however, the correlation is high, the relationship between intelligence measure and outcome parameter performance is strong and thus a large correction can be made on this basis. The correlation is essentially a measure of the confidence in the ability to correct outcome parameter performance on the basis of intelligence measures.

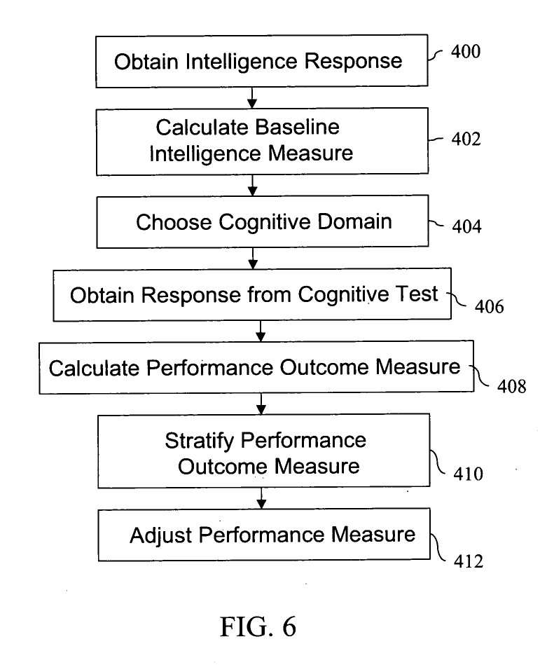

Referring now to both FIG. 4 and FIG. 6, FIG. 6 is a flow chart illustration of the steps of a method of adjusting a performance outcome measure based on a baseline intelligence measure, in accordance with another embodiment of the present invention. First, intelligence data receiver 118 obtains (step 400) responses to intelligence test 12. Next, IQ calculator 221 calculates (step 402) a baseline intelligence measure from intelligence test 12. Next, the user chooses (step 404) a cognitive domain to test. The step of choosing a cognitive domain can also be performed prior to the steps of obtaining responses to intelligence test 12 and calculating a baseline intelligence measure. In preferred embodiments, the user is a clinician, such as a neurologist, psychologist, neuropsychologist, or any other individual suitable for collecting cognitive data. The chosen cognitive domain may be a specific category, such as memory or attention. Alternatively, the chosen cognitive domain may be a condition or a general area of cognition, such as mild cognitive impairment (MCI) or traumatic brain injury (TBI). Batteries for various conditions are available, for example, through Mindstreams® (Neurotrax Corp., NY). Performance data receiver 116 then obtains (step 406) responses from cognitive test 10. Calculator 120 then calculates (step 408) a performance outcome measure from the responses. The steps of obtaining responses and calculating a performance outcome measure may be performed during the same testing session as obtaining a baseline intelligence measure (step 400), or at a later date. In one embodiment, the performance outcome measure is a single outcome from a single trial of a test. Raw performance measures are converted to a standardized scale (such as an IQ scale or a z-scale). Comparator 122 then stratifies (step 410) the performance outcome measure according to intelligence level. That is, the performance outcome measure is categorized based on the intelligence measure. Thus, if the intelligence measure indicates that the subject is of high intelligence, the data is automatically sent to a high intelligence category. Adjustor 224 adjusts (step 412) the performance outcome measure calculated in step 408 to reflect the categorization by normalizing based on the stratification category. This is done by converting the raw score to a normalized score, wherein the normalization is done for age, education, and intelligence. In a preferred embodiment, the normalization is accomplished by dividing the difference between the raw score and the normative score by the normative standard deviation. Normative scores based on experimental data obtained from the normative sample, and are categorized according to age, education and intelligence. The adjusted performance outcome measure can then be converted into index scores, based on at least two outcomes from a single trial of a test or at least one outcome from each of at least two tests (wherein both tests are designed to test a similar cognitive skill) or into composite scores, calculated from a combination of at least two index scores designed to test a similar cognitive skill. Calculation of index scores and composite scores are described more fully in co-pending U.S. patent application Ser. No. 10/370,463 and in co-pending U.S. patent application Ser. No. 10/971,067, both of which are incorporated herein by reference in their entireties.

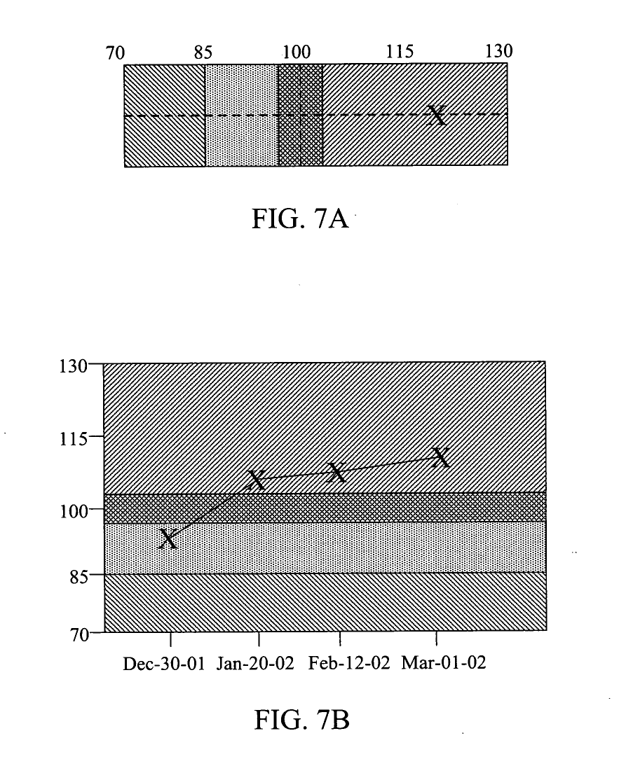

Reference is now made to FIGS. 7A and 7B, which are illustrations of graphs which may be included in report 20. Report 20 is available shortly after testing, either over the internet or by any other communication means. Report 20 includes a summary section and a detailed section. In the summary section, scores on cognitive tests are reported as normalized for age and educational level, and are presented with and without IQ adjustments. Scores are presented in graphical format, as depicted in FIG. 7A, indicating where the score fits into pre-defined ranges and sub-ranges of performance. Report 20 also includes graphical displays showing longitudinal tracking (scores over a period of time) for repeat testing, as shown in FIG. 7B. The detailed section includes further details, such as raw and normalized scores for each repetition. Thus, a clinician is able to either quickly peruse the summary section or has the option of looking at specific details regarding the scores and breakdown. Each of these sections can also be independently provided.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. For example, other formulae or methods for adjusting cognitive scores based on intelligence scores as compared to a normative sample may be possible and would fall within the scope of the invention. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Validation of Discrepancy-Based IQ Adjustment:

An analysis of discrepancy based IQ adjustment was done to validate the use of the system and method of the present invention in accordance with one preferred embodiment. The analysis and validation is described hereinbelow.

Methods

Study Sample:

The main analyses were conducted on data from 633 participants in controlled research studies using Mindstreams® (NeuroTrax Corp., NY) computerized tests. Each participant received an expert diagnosis (Table 1), which was taken as the gold standard. Expert diagnoses were based on the judgment of physicians relying on patient history, physical examination, and ancillary laboratory or imaging data, as necessary. For patients with multiple visits, only data from the first visit was included. Only patients whose primary language (i.e., most comfortable using, language used most often) was available as a Mindstreams test language were included.

MCI Score Derivation Sample:

A secondary set of analyses was conducted on 306 participants (265 of whom were also in the Study Sample) in controlled research studies using Mindstreams® tests. This dataset was the subset of patients who received the Problem Solving test in a larger (N=341) dataset used to derive the pass/fail cutoffs for the MCI Score. As in the Study Sample, expert diagnosis was taken as the gold standard, only data from first visits was included, and all patients took Mindstreams® in their primary language.

External Clinical Sample:

A tertiary set of analyses was conducted on 52 patients who were administered a Mindstreams® battery including the Problem Solving test as part of a neuropsychological evaluation in a clinical setting. Only data from first visits was included.

The Mindstreams® tests sampled various cognitive domains, including memory (verbal and non-verbal), executive function, visual spatial skills, verbal fluency, attention, information processing, and motor skills.

Participants were given a Problem Solving test, as described above, to measure Non-Verbal IQ. All responses were made with the mouse or with the number pad on the keyboard. Patients were familiarized with these input devices at the beginning of the battery, and practice sessions prior to the individual tests instructed them regarding the particular responses required for each test.

Outcome parameters varied with each test. Given the speed-accuracy tradeoff, a performance index (computed as [accuracy/reaction time]*100) was computed for timed Mindstreams® tests in an attempt to capture performance both in terms of accuracy and reaction time. To minimize differences in age and education and to permit averaging performance across different types of outcome parameters (e.g., accuracy, reaction time), each outcome parameter was normalized and fit to an IQ-style scale (mean: 100; SD: 15) in an age- and education-specific fashion.

Normalization

Normalization was according to a normative sample consisting of 605 participants with an expert diagnosis of cognitively healthy in controlled research studies using Mindstreams®. Of the 325 cognitively healthy individuals in the Study Sample, 175 were also part of the normative sample. Data was normalized by the stratifications presented in Table 1.

TABLE 1

| Years of Education | Age Group | N¹ |
|---|---|---|
| <12 | <12 | 30 |
| | >12 and <18 | 29 |
| | >18 and <50 | 70 |
| | >50 and <70 | 41 |
| | >70 | 42 |
| >12 | >18 and <30 | 148 |
| | >30 and <40 | 45 |
| | >40 and <50 | 46 |
| | >50 and <60 | 31 |
| | >60 and <70 | 50 |
| | >70 and <75 | 32 |
| | >75 | 41 |

¹Maximum across all outcome parameters.

Index Scores

Normalized subsets of outcome parameters were averaged to produce seven summary scores as follows, each indexing a different cognitive domain:

MEMORY: mean accuracies for learning and delayed recognition phases of Verbal and Non-Verbal Memory tests

EXECUTIVE FUNCTION: performance indices (accuracy divided by reaction time (RT)) for Stroop Interference test and Go-NoGo Response Inhibition (either standard or expanded) test, mean weighted accuracy for Catch Game

VISUAL-SPATIAL: mean accuracy for Visual Spatial Orientation test

VERBAL: weighted accuracy for verbal rhyming test (part of Verbal Function test)

ATTENTION: mean reaction times for Go-NoGo Response Inhibition (either standard or expanded) and choice reaction time (a non-interference phase of the Stroop test) tests, mean standard deviation of reaction time for Go-NoGo Response Inhibition test, mean reaction time for a low-load stage of Staged Information Processing Speed test, mean accuracy for a medium-load stage of Staged Information Processing Speed test

INFORMATION PROCESSING SPEED: performance indices (accuracy divided by RT) for various low- and medium-load stages of Staged Information Processing Speed test

MOTOR SKILLS: mean time until first move for Catch Game, mean inter-tap interval and standard deviation of inter-tap interval for Finger Tapping test

These seven index scores served as the primary dependent variables for the present analysis. A Global Cognitive Score (GCS) computed as the average of these index scores served as a secondary dependent measure.

MCI Score

For cognitive assessment in older individuals, 6 normalized outcome parameters particularly relevant for identification of MCI and mild dementia were used to compute an ‘MCI Score’. These outcome parameters were: 1) Verbal Memory: accuracy, all repetition trials; 2) Non-Verbal Memory: accuracy, all repetition trials; 3) Go-NoGo: performance index; 4) Stroop: performance index for Stroop interference phase; 5) Visual Spatial Imagery: accuracy; and 6) Catch Game: total score (summed accuracy across levels, weighted by difficulty). A pass/fail determination was made for each outcome parameter on the basis of the cutoff value with equivalent sensitivity and specificity for distinguishing among patients with an expert diagnosis of cognitively healthy and those with a diagnosis of mild dementia. The total number of outcome parameters ‘failed’ was computed and the result converted to a 10-point scale. This scale was split into three performance zones, a ‘Normal’ zone from 0 to 2.5, a ‘MCI’ zone between 2.5 to 7.5, and a ‘Dementia’ zone from 7.5 to 10.

Discrepancy-Based IQ Adjustment

Normalized Problem Solving test score and outcome parameter data were initially converted to the z scores z_{IQ} and z_{OP} respectively. Expected outcome parameter performance, Z_{EOP}, was then estimated by the regression equation Z_{EOP}=r_{IQOP}×Z_{IQ}, where r_{IQOP} is the strength of correlation (Pearson's r) between raw Problem Solving test score and outcome parameter performance in the appropriate stratification of the normative sample. Then, the discrepancy score was computed as Z_{EOP}−Z_{OP} and its standard deviation as (1−r²_{IQOP}). The discrepancy score was divided by its standard deviation to give a standardized discrepancy score: (Z_{EOP}−Z_{OP})/(1−r²_{IQOP}). Finally, the z score value given by the standard discrepancy score was converted into normalized units to give IQ-adjusted outcome parameter performance.

Table 2 depicts a representative pattern of correlations between raw Problem Solving score and outcome parameter performance, obtained from the normative sample.

TABLE 2

| Outcome Parameter | Pearson's r |
|---|---|
| Accuracy | 0.08 |
| Reaction Time | −0.38 |
| Performance Index | 0.30 |
| Standard Deviation of Reaction Time | −0.50 |
| Commission Errors | −0.07 |
| Omission Errors | −0.12 |
| Reaction Time for Errors of Commission | −0.39 |

Correlations are shown for Go-NoGo test outcome parameters for individuals in the normative sample 50 to 60 years old with more than 12 years of education. It can be appreciated that direction of correlation varies with the type of outcome parameter. Accuracy and performance index outcome parameters show a positive correlation with Problem Solving test score, indicating that a higher Problem Solving test score is associated with higher accuracy and a larger performance index. Conversely, the remaining outcome parameters show a negative correlation with Problem Solving test score, indicating that a higher Problem Solving test score is associated with shorter and less variable reaction time and fewer errors. It can also be appreciated that strength of correlation is variable across outcome parameters. Standard deviation of reaction time correlated most strongly with Problem Solving test score, while errors of commission showed the weakest correlation. Average correlation across Go-NoGo outcome parameters was between 0.20 and 0.30.

Analyses

To examine the validity of discrepancy-based IQ adjustment for Mindstreams® outcome parameters using Problem Solving test score, the following were computed for index scores and the GCS: 1) mean unadjusted and IQ-adjusted performance; 2) mean absolute difference between unadjusted and IQ-adjusted performance; 3) percentage of patients with higher, lower, or identical scores with IQ-adjustment; 4) percentage of patients scoring in a performance sub-range reflecting less impairment (e.g., Probable Normal→Normal), more impairment (e.g., Probable Normal→Probable Abnormal), or the same level of impairment (e.g., Probable Normal→Probable Normal) with IQ-adjustment; 5) False positive (Type I error; p[FP]) and false negative (Type II error; p[FN]) rates for performance sub-range cutoffs for unadjusted and IQ-adjusted performance.

For additional validation, percentage of patients scoring in a performance sub-range reflecting less impairment, more impairment, or the same level of impairment with IQ adjustment was computed for an entire high-education (years of education: 16.74±3.58) cohort drawn from the study sample (N=49).

Finally, new pass/fail cutoffs using IQ-adjusted outcome parameters were computed for the MCI Score in the MCI Score Derivation Sample and compared with cutoffs computed using unadjusted outcome parameters. Percentage of patients scoring in a performance sub-range reflecting less impairment, more impairment, or the same level of impairment with IQ adjustment were computed for each of the 6 outcome parameters, separately for cognitively healthy and mild dementia patients to further evaluate the shift in MCI Score cutoffs with IQ-adjustment.

Results

Study Sample:

Mean IQ-adjusted index scores and GCS were comparable to their unadjusted counterparts for the entire Study Sample, though generally slightly higher, reflecting a net effect of score improvement. As anticipated, mean IQ-adjusted scores were consistently higher for lower IQ individuals and consistently lower for higher IQ individuals and scaled with IQ, such that the more extreme the IQ the larger the adjustment, as shown in Table 3.

TABLE 3

| Mindstreams ® | | | Low | Low-Medium | Medium-High | High |
|---|---|---|---|---|---|---|
| Measure | | All | (≦85) | (>85 and ≦96.25) | (>96.25 and ≦103.75) | (>103.75) |
| Memory | Unadjusted | 92.64 | 82.44 | 88.60 | 94.35 | 98.81 |
| | IQ-Adjusted | 93.04 | 87.70 | 90.03 | 93.99 | 96.58 |
| Executive | Unadjusted | 93.28 | 84.53 | 91.85 | 93.80 | 98.31 |
| Function | IQ-Adjusted | 93.69 | 90.49 | 94.10 | 93.61 | 95.31 |
| Visual | Unadjusted | 96.29 | 86.24 | 91.26 | 96.79 | 103.39 |
| Spatial | IQ-Adjusted | 97.07 | 95.70 | 93.81 | 96.72 | 99.29 |
| Verbal | Unadjusted | 90.94 | 77.84 | 89.89 | 89.80 | 99.04 |
| Function | IQ-Adjusted | 91.06 | 84.22 | 92.51 | 89.27 | 95.11 |
| Attention | Unadjusted | 92.76 | 83.37 | 88.48 | 95.54 | 98.24 |
| | IQ-Adjusted | 93.23 | 89.60 | 90.34 | 95.21 | 95.39 |
| Information Processing | Unadjusted | 94.28 | 85.15 | 91.74 | 95.47 | 98.53 |
| Speed | IQ-Adjusted | 94.17 | 90.52 | 94.17 | 95.40 | 95.21 |
| Motor | Unadjusted | 95.54 | 87.53 | 94.31 | 96.40 | 99.65 |
| Skills | IQ-Adjusted | 95.91 | 92.78 | 96.10 | 96.36 | 97.23 |
| Global Cognitive | Unadjusted | 93.28 | 83.46 | 90.04 | 94.32 | 99.29 |
| Score | IQ-Adjusted | 93.69 | 89.76 | 92.16 | 94.08 | 96.19 |

Mean absolute difference between unadjusted and IQ-adjusted performance was about 3 normalized units for entire Study Sample. The pattern of correction across subdivisions of IQ reveals greater correction for lower IQ as compared to higher IQ individuals. For Low-IQ individuals the difference is about 6 normalized units, whereas for High-IQ individuals the difference is similar to that of the entire Study Sample. Hence the effect of adjustment seems greater for Low-IQ individuals, consistent with the net effect of score improvement in the prior result.

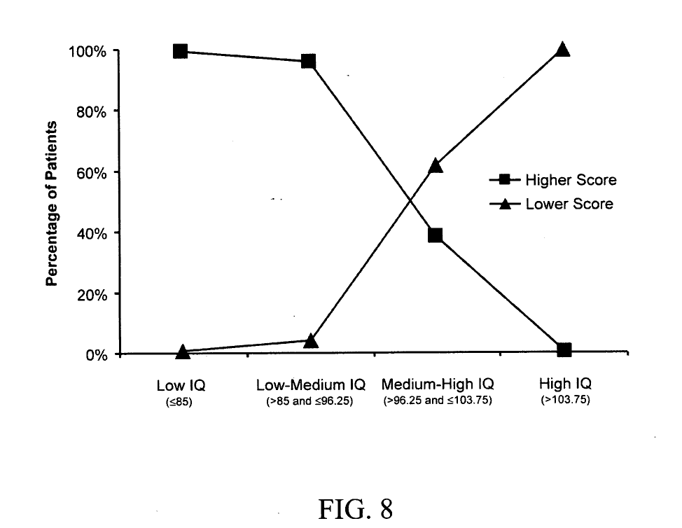

For the entire Study Sample slightly fewer than half the scores were higher with IQ-adjustment and slightly more than half lower. The pattern of correction across subdivisions of IQ reveals that the vast majority of Low-IQ individuals received a higher score and the vast majority of High-IQ individuals received a lower score, as shown in FIG. 8. Interestingly, a greater percentage of Low-Medium IQ than Medium-High IQ individuals received a higher score, further supporting the observation that, at least in this sample, IQ-adjustment is more pronounced for lower-IQ individuals as compared to higher-IQ individuals.

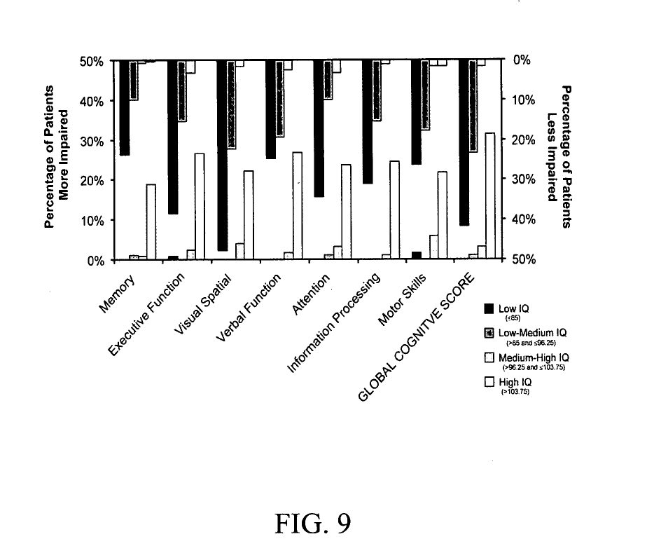

In examining the frequency of shifts in performance sub-range with IQ-adjustment in the entire Study Sample, only 20-25% of patients shifted performance sub-range with IQ-adjustment. Even among Low-IQ and High-IQ individuals, only about 30% of individuals shift performance sub-range with adjustment, the Low-IQ individuals in the less impaired direction and the High-IQ individuals in the more impaired direction, as shown in FIG. 9. Consistent with the above results, more Low and Low-Medium IQ individuals score in a less impaired performance sub-range with adjustment than Medium-High and High IQ individuals score in a more impaired performance sub-range with adjustment.

Frequency of shifts in performance sub-ranges was also examined in a high-education cohort drawn from the Study Sample to validate the IQ-adjustment in a group of High-IQ individuals not classified by the same test used for the adjustment. Similar to the analysis of the entire Study Sample with subdivisions of IQ by Problem Solving test score, only 20-25% of patients shifted performance sub-ranges. For all index scores and the GCS, the vast majority of those who did switch performance sub-ranges shifted in the more impaired direction, with only a minority switching in the less impaired direction.

Shifts in performance sub-ranges were also examined in the External Clinical Sample to examine clinical implications of IQ-adjustment in an independent clinical cohort. About 25-30% of patients shifted performance sub-ranges. Across index scores and the GCS, shifts were generally in the anticipated direction, with Low-IQ individuals shifting to a performance sub-range reflecting greater impairment and High-IQ individuals shifting to a performance sub-range reflecting less impairment. In this cohort the pattern of shifts appeared more balanced than in the Study Sample, with more similar percentages of lower and higher IQ individuals shifting performance sub-ranges. Further, there were some instances where there was no shift in performance zone at all (e.g., Low-Medium IQ subgroup, Information Processing Speed index score) and differential patterns across IQ subgroups (e.g., for the Motor index score, a greater percentage of Low-Medium IQ individuals shifted to a more impaired performance sub-range, whereas for the other index scores, a greater percentage of these individuals shifted to a less impaired sub-range). Future studies might address such differential patterns of shift in performance sub-range as a function of cohort, diagnosis, cognitive domain and IQ subgroup.

Pass/fail cutoffs for the 6 MCI Score outcome parameters computed with IQ-adjusted data in the MCI Score Derivation Sample revealed a consistent rise in the cutoffs as compared to the cutoffs previously computed with unadjusted data. Hence the consequence of IQ-adjustment for computation of the MCI Score is that it is harder to pass (i.e., a passing score with the unadjusted data might now be a failing score). Thus shifts in performance sub-range with adjustment were examined in the cognitively healthy and mild dementia patients used to derive the cutoffs. Mean percentage of cognitively healthy patients shifting to a less impaired performance sub-range across all 6 outcome parameters was 12.45%; mean percentage shifting to a more impaired sub-range was 10.45%. In contrast, mean percentage of mild dementia patients shifting to a less impaired performance sub-range across all 6 outcome parameters was 25.20%; mean percentage shifting to a more impaired sub-range was 4.94%. Hence the rise in cutoffs may be attributable to greater effect of IQ-adjustment upon the mild dementia group, making them better performers relative to the cognitively healthy group and hence making it reasonable that a higher score is needed to “pass” and be classified as not demented.

Using the same Study Sample as the present study (but also including those who did not receive the Problem Solving test), a previous analysis, described in detail in co-pending U.S. application Ser. No. 10/971,067, filed on Oct. 25, 2004, and incorporated herein by reference in its entirety, defined four performance sub-ranges (i.e., Abnormal, Probable Abnormal, Probable Normal, Normal) defined by three cutoffs (Abnormal/Probable Abnormal: 85; Probable Abnormal/Probable Normal: 96.25; Probable Normal/Normal: 103.75). Each cutoff was selected on the basis of p(FP) and/or p(FN) for identifying cognitive deficits anticipated to be impaired on the basis of an expert diagnosis “gold standard”. p(FP) and p(FN) were computed for each index score and the GCS for abnormal diagnoses anticipated to evidence impairment. The present analysis sought to examine the effect of IQ-adjustment relative to the desired p(FP) and/or p(FN) for each cutoff as defined in the previous analysis. As spurious error rate estimates may be obtained with very small sample sizes, p(FN) was not calculated for analyses with fewer than 10 abnormal individuals.

In the previous analysis, 85 (i.e., −1SD) was designated the Abnormal/Probable Abnormal cutoff because its p(FP) approximated 0.10. Table 12 indicates that across index scores and the GCS, the p(FP) indeed approximates 0.10 for both the unadjusted and IQ-adjusted scores. However, in Low-IQ individuals, the unadjusted score for some summary measures deviates markedly from the target of 0.10, reflecting an undesirably high error rate in classifying Low-IQ individuals as cognitively impaired when in actuality they are not. With IQ-adjustment, p(FP) for low-IQ individuals is reduced so that it approximates 0.10, and although there is an accompanying rise in the p(FP) for High-IQ individuals, the error rates for this subgroup continue to approximate 0.10.

96.25 (i.e., −0.25SD) was designated the Probable Abnormal/Probable Normal cutoff in the previous analysis because its p(FP) and p(FN) approximated 0.30. Table 13 indicates that across index scores and the GCS, the p(FP) and p(FN) indeed approximates 0.30 for both the unadjusted and IQ-adjusted scores. However, in Low-IQ individuals, the unadjusted score for some summary measures deviates markedly from the target p(FP) of 0.30, reflecting an undesirably high error rate in classifying Low-IQ individuals as cognitively impaired when expert diagnosis indicates they are not impaired. Additionally, in High-IQ individuals, the unadjusted score for some index scores deviates markedly from the target of p(FN) of 0.30, reflecting an undesirably high error rate in classifying High-IQ individuals as not cognitively impaired when expert diagnosis indicates that they are, in fact, impaired. With IQ-adjustment, p(FP) for Low-IQ individuals and p(FN) for High-IQ individuals is reduced so that it better approximates 0.30, and although there is an accompanying rise in p(FN) for Low-IQ individuals and in p(FP) for High-IQ individuals, all error rates approximate 0.30.

Finally, 103.75 was designated the Probable Normal/Normal cutoff in the previous analysis because its p(FN) approximated 0.10. In the present analysis, across index scores and the GCS, the p(FN) indeed approximates 0.10 for both the unadjusted and IQ-adjusted scores. However, in High-IQ individuals, the unadjusted score for some summary measures deviates markedly from the target of 0.10, reflecting an undesirably high error rate in classifying High-IQ individuals as cognitively healthy when in actuality they are impaired. With IQ-adjustment, p(FN) for High-IQ individuals is generally reduced so that it better approximates 0.10, and although there is an accompanying rise in the p(FN) for Low-IQ individuals, the error rates for this subgroup continue to approximate 0.10.

### CONCLUSIONS

The present study describes the application of a regression-based discrepancy approach to the adjustment of Mindstreams® computerized cognitive data for IQ. In a heterogeneous study sample containing individuals with a variety of ages, educational levels, and cognitive diagnoses, the adjustment was in the expected direction, reducing the scores of high-IQ individuals and conversely raising the scores of low-IQ individuals. The vast majority of individuals remained in the same performance sub-range with adjustment, but 20-25% of individuals shifted performance sub-range, either in the less impaired direction for low-IQ individuals or in the more impaired direction for high-IQ individuals. The adjustment was found to be more prevalent for low-versus high-IQ individuals. This disparity may be attributable to sample characteristics as it was not apparent in an external clinical sample. Importantly, misclassification rates in each of the Mindstreams® performance sub-ranges were reduced with adjustment such that fewer low-IQ individuals were incorrectly classified as cognitively impaired and fewer high-IQ individuals were misclassified as cognitively healthy relative to expert diagnosis.

These findings suggest that automatic IQ adjustment based upon Mindstreams® Problem Solving test score represents a significant scientific and technical improvement to the Mindstreams® system, improving validity of classification without the practical difficulties and scientific limitations inherent in manual IQ-adjustment as described in the LD literature.

What is claimed is:

1. A system for cognitive testing, the system comprising:
a cognitive test, configured to provide at least one cognitive performance outcome;
an intelligence test, configured to provide an intelligence measure; and
a processor comprising:
a performance data receiver, for receiving said at least one cognitive performance outcome;
an intelligence data receiver, for receiving said intelligence measure; and
an adjustor for adjusting said at least one cognitive performance outcome based on said intelligence measure.

2. The system of claim 1, wherein said cognitive test comprises:
a battery of tests for measuring a neurological parameter, said battery of tests specifically tailored for said subject based on information about said subject and based on a determination about which cognitive skill to measure; and
an interface allowing a clinician to access said battery of tests and administer said battery of tests to said subject, said subject generating data in response to said administered battery of tests.

3. The system of claim 1, wherein said at least one cognitive performance outcome is an outcome from a single trial.

4. The system of claim 1, wherein said at least one cognitive performance outcome is an index score, said index score calculated from several trials.

5. The system of claim 1, wherein said at least one cognitive performance outcome is a composite score, said composite score calculated from more than one trial of more than one test.

6. The system of claim 1, wherein said intelligence test is a non-verbal IQ test.

7. The system of claim 6, wherein said intelligence test is a Problem Solving test.

8. The system of claim 1, further comprising a display for presenting said adjusted cognitive performance outcome.

9. The system of claim 8, wherein said display is a report, and wherein said adjusted cognitive performance outcome is presented in graphical format.

10. A method of cognitive testing, the method comprising:
obtaining a measure of intelligence;
obtaining a performance outcome measure for a cognitive skill from a computerized cognitive test;
comparing said performance outcome measure to an expected performance outcome measure based on said measure of intelligence; and
quantifiably adjusting said performance outcome measure based on said comparison.

11. The method of claim 10, wherein said comparing comprises calculating a discrepancy from an expected performance outcome measure.

12. The method of claim 11, wherein said expected performance outcome measure is calculated based on correlations of intelligence to said cognitive skill.

13. The method of claim 10, wherein said comparing comprises stratifying said obtained performance outcome measure according to normative intelligence measures.

14. A method of cognitive testing, the method comprising:
obtaining a measure of intelligence;
obtaining a performance outcome measure from a computerized cognitive test for a cognitive parameter;
calculating an expected performance outcome measure based on correlations of intelligence to said cognitive parameter;
calculating a discrepancy between said obtained performance outcome measure and said expected performance outcome measure; and
adjusting said obtained performance outcome measure based on said discrepancy.

15. A method of cognitive testing, the method comprising:
obtaining a measure of intelligence;
obtaining a performance outcome measure from a computerized cognitive test;
stratifying said obtained performance outcome measure according to said measured intelligence; and
adjusting said obtained performance outcome measure based on said stratification.
